(19) United States
(12) Patent Application Publication
(10) Pub. No.: US 2022/0056938 A1
(43) Pub. Date: Feb. 24, 2022

(54) DOWEL FASTENERS

(71) Applicant: INTELLIGENT FIXINGS LIMITED, London (GB)

(72) Inventor: Luke Thomson, London (GB)

(73) Assignee: INTELLIGENT FIXINGS LIMITED, London (GB)

(21) Appl. No.: 17/274,833

(22) PCT Filed: Sep. 10, 2019
(86) PCT No.: PCT/EP2019/074146

§ 371 Date: Mar. 10, 2021

(30) Foreign Application Priority Data
Sep. 10, 2018 (GB) 1814696.9

(51) Int. Cl. F16B 12/24; F16B 13/02; F16B 13/12

(52) U.S. Cl. CPC F16B 12/24; F16B 13/128; F16B 13/02

(57) ABSTRACT

A fixing is described with a head portion (2), preferably formed as a headed stud (8, 9), and a dowel portion (1). The dowel portion (1) has a generally polygonal, preferably square, cross-section, and on each face is formed a series of barbs (4). The fixing is designed to be hammered into a hole of internal diameter corresponding to the external size of the shaft. Once inserted, the barbs (4) prevent easy extraction, e.g. from a chipboard or mdf-based furniture component. The fixing may have an axial hole (12) through which a secondary fixing, such as a headed screw, may pass, in order to render the force needed to pull the fixing out even greater.

This invention relates to dowel fasteners, particularly for use in furniture construction, and, more particularly, to fasteners having a dowel portion for insertion into a pre-drilled hole in a furniture component and a head structure, for example in the form of a headed stud, which may engage with another furniture component having a stepped recess into which the stud may be inserted.

While the use of conventional short wooden dowels which are inserted into pre-drilled holes in furniture components is still widespread, there have been many proposals to use instead pre-formed dowels of plastics material where the dowel has projecting fins around a circular shaft and where the external diameter of the fins is slightly larger than the internal diameter of the hole into which the dowel is to be inserted. Examples of such a dowel structure are seen in WO 2017/015402 and WO 2016/015493.

WO 2015/117160 describes a push fastener which can be inserted by hand and which has a series of longitudinally spaced barbs around a shaft, where one end of the shaft is rounded to assist insertion into a pre-drilled hole while the other end of the shaft has a cap with a wedge structure which engages, for example, the edges of a hole formed in a backing sheet of a piece of furniture, so as to hold that backing sheet against other components of the piece of furniture when the fastener is pushed in.

FR-2161175 discloses a moulded fastener structure which in use has a central shaft with lateral fins. The shaft is hollow and, the shaft is pushed into a pre-drilled hole, the fins are deflected upwards towards the open end of the hole and so act as barbs making it difficult to remove the shaft. The specification discloses an embodiment in which the moulded unit may incorporate a threaded short stud which acts as a head on to which a nut may be screwed. Alternatively, the fastener may be used in a fashion similar to a wall plug, with a wood screw or threaded bolt screwed into the central axial bore of the fixing after it has been inserted into a pre-formed hole.

The use of barbs on the side of elongate push-in fasteners to render them relatively easy to push in but more difficult to remove is known in a wide variety of fasteners. Thus, GB2547210A, EP0365161A and US2010/0021267 all disclose fasteners with a set of barbs on each side of a central shank. Such fasteners are not suitable as dowels in connecting components of furniture together, in particular since they do not react evenly irrespective of the direction of force exerted on them in a direction perpendicular to the longitudinal extent of the shank.

Other plastics drive fasteners are disclosed in GB2077845A and GB1451009A. the fasteners described in these specifications are not suitable for use in furniture construction because of the difference in behaviour depending upon the angle at which they are stressed, arising from the need to restrict the angled barbs to two opposite sides of the shank in order to enable simple two-part moulds to be used.

US2011/0117355A discloses a fastener specifically for use in furniture construction but for use in applying ornamental rather than load-bearing components to the underlying structure.

We have now found that improved performance may be secured by dowel constructions which have a polygonal cross-section central shaft and, extending from each of the faces of the shaft a set of a series of barbs longitudinally spaced along the shaft, wherein the exterior diameter of the contour of the barbs and the diameter of a hole into which the polygonal shaft is a press fit are substantially the same.

Dowel fasteners constructed in this way need to be hammered in or push-fitted using fairly considerable force but, once inserted, are very difficult to remove because the relatively small extent of the projection of the barbs from the central shank means that the barbs cannot easily be flexed if an attempt is made to pull the dowel out.

According generally to the present invention, there is provided a fixing for insertion into a cylindrical cavity formed of a slightly resilient plastics material having a head portion and a shaft extending therefrom, the shaft having a generally polygonal cross-section and the faces of the shaft carrying a series of barbs having an arcuate edge, the exterior profile of the barbs being slightly greater than the interior diameter of the cavity and the shaft being a close fit within the cavity. Preferably the shaft is of square cross-section, though other polygonal cross-sections may be envisaged, for example triangular, pentagonal or hexagonal.

The external diameter of the barbed portion of the shaft is preferably no more than 3% greater than the diameter of a circle tangent to the apices of the polygonal shaft cross-section.

The faces of the shaft may be flat or slightly convex or concave. A particularly preferred configuration for each face of the shaft is a flat strip adjacent each edge of the face and a slightly raised rib between them.

The fixings in accordance with the present invention are designed for use with holes of internal diameter substantially equal to the external size of the shaft so that the shaft is a tight fit in the hole with its edges, the apices of the polygonal shape, in contact with the sides of the hole. The barbs extend from the faces of the shaft with their exterior size being slightly greater than the interior diameter of the hole into which the fixing is to be inserted, so they are compressed or distorted when the fixing is inserted, usually by hammering or with a press bench tool.

The barbs preferably extend substantially across the entire width of the face of the shaft, though it is possible to conceive of fixings where the barbs do not extend to the edges of each face.

The barbs are preferably of a shape where one side is flat and shaped like the geometrical segment of a circle while the other side is frusto-conical or bowed, in either case being essentially convex. Such a construction enables the fasteners to be made by injection moulding using simple two-part moulds because there are no re-entrant portions on the barbs, i.e. when the fastener is made the barbs do not incline generally back towards the head of the fastener.

A particularly preferred form of dowel fastener in accordance with the invention has a head portion forming a stud. The preferred shape of the head portion is of a cylindrical or slightly conical section of external diameter slightly greater than the diameter of the polygonal section shaft (so that the transition between head and shaft constitutes a shoulder which can come to lie against the surface of the furniture component from which the hole extends and into which the fastener is driven) and having a cap, the underside of which is annular in a plane perpendicular to the elongation of the shaft and the top being conical, domed or frusto-conical as desired.

Although such a fixing may be configured so that it sits very firmly once inserted into the pre-drilled hole and resists being pulled therefrom axially, it is sometimes desired to provide even greater resistance to being pulled out, and this may be easily achieved if the fixing in accordance with the present invention has a central axial hole through which a secondary fastener may be passed, for example a pin or a threaded screw which is longer than the fastener itself and the leading end of which may accordingly be engaged with the material of the component into which the hole has been drilled for the reception of the fastener in accordance with the invention. In such fixings, the faces of the shaft are preferably slightly convex or flat with a central rib, in order that the presence of the central axial hole does not overly weaken the strength or integrity of the fixing itself.

Fasteners in accordance with the present invention may be made by injection-moulding from suitable plastics materials, for example glass fibre reinforced Nylon 6, to tight tolerances.

By way of example, a fastener in accordance with the present invention is illustrated in the accompanying drawings in which:

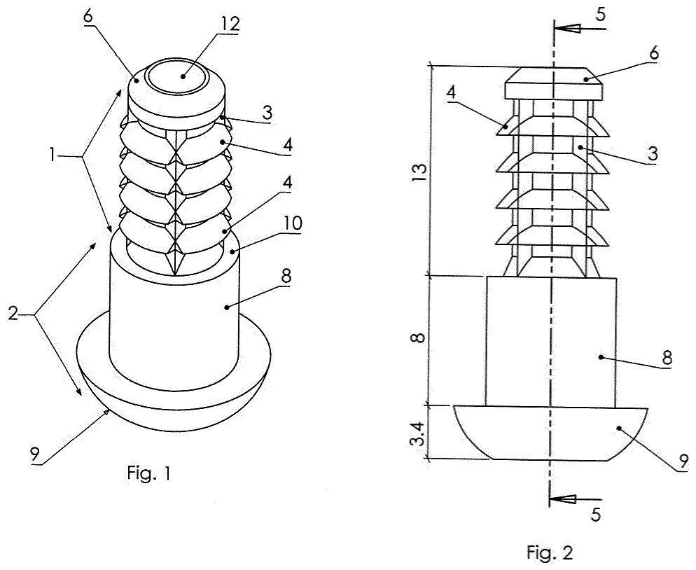

FIG. 1 is a perspective view of a fastener in accordance with the present invention;

FIG. 2 is a side view of the fastener shown in FIG. 1;

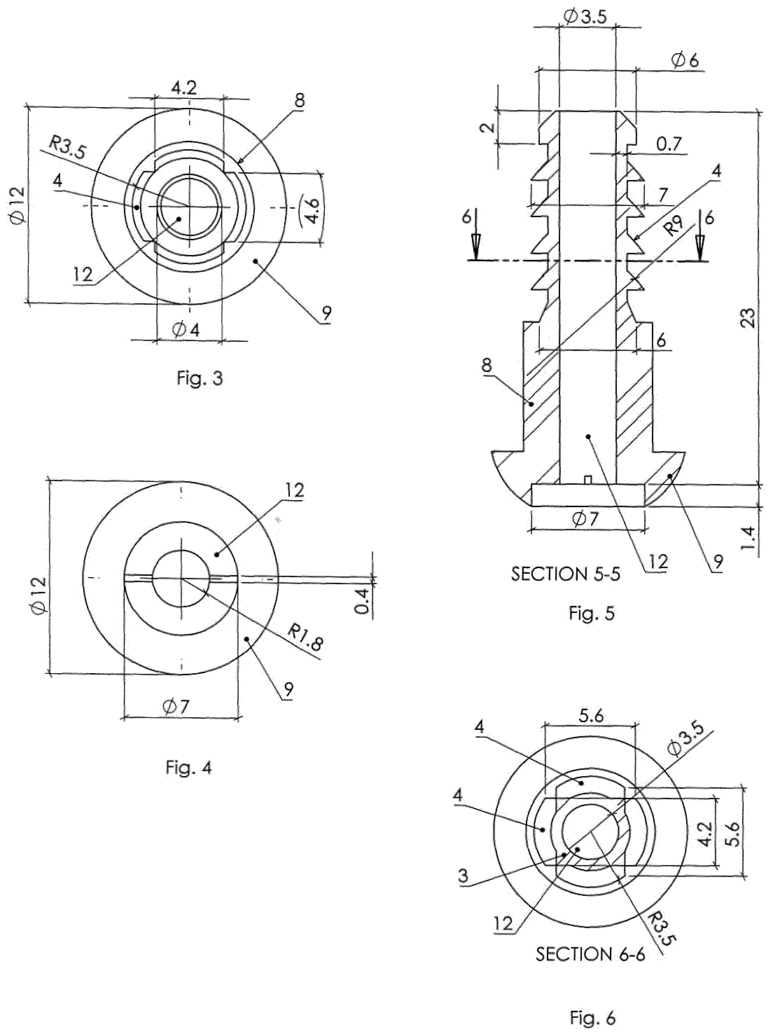

FIGS. 3 and 4 are end views of the fastener, FIG. 3 being from the dowel portion end and FIG. 4 being of the head;

FIG. 5 is a longitudinal section of the fastener along the lines 5-5 in FIG. 2; and

FIG. 6 is a cross-sectional view along the lines 6-6 in FIG. 5.

Referring to the drawings, the dowel fastener according to the present invention illustrated in them consists basically of a dowel portion 1 and a head portion 2. The dowel portion 1 consists of a square section shaft 3 having on each of its four faces a set central low profile convex rib and of four moulded barbs 4. As can be seen most clearly in FIG. 6, the barbs 4 extend outwards from the square section shaft 3 so that they have an external size greater than the diagonal measurement between two corners of the shaft 3. The end of the shaft 3 has a circular, part frusto-conical cap 6. The frusto-conical shape means that the fastener may be positioned slightly extending into a pre-drilled hole before being inserted into that hole, e.g. using a hammer or mallet.

The head portion 2 is formed of a cylindrical section 8 and an end cap 9. The diameter of section 8 is slightly larger than the overall size of the dowel portion 1 so as to form a shoulder 10 which, when the fastener is inserted into the pre-drilled hole, abuts the surface of the material in which the hole is drilled.

The fastener illustrated has a central bore 12 through which a long woodscrew may be passed if it is desired, once the fastener has been inserted into a furniture component, to anchor it even more firmly against being pulled out from that component. The surface of the central low profile convex ribs is concentric with the axis of the dowel portion, as can be seen most clearly in FIG. 6.

The dimensions shown on the drawings are in millimetres, and as can be seen the particular fastener shown is designed to be inserted into a hole of 7 mm internal diameter.

1. A fixing for insertion into a cylindrical cavity, the fixing being formed of a slightly resilient plastics material having a head portion and a shaft extending therefrom, the shaft having a generally polygonal cross-section and the faces of the shaft carrying a series of barbs having an arcuate edge, wherein the exterior profile of the barbs is slightly greater than the interior diameter of the cylindrical cavity, and the polygonal cross-section shaft is a close fit within the cylindrical cavity.

2. The fixing according to claim 1 wherein the shaft is of square cross section.

3. The fixing according to claim 1 wherein each face of the shaft comprises a flat strip adjacent each edge of the face and a raised rib between them.

4. The fixing according to claim 1 wherein the barbs extend substantially across the entire width of each face of the shaft.

5. The fixing according to claim 1 wherein the barbs are shaped like a flat geometrical segment of a circle on one side and have a frusto-conical or generally convex shape on the other side of the barb.

6. The fixing according to claim 1 wherein the head portion forms a stud, comprising a cylindrical or slightly conical section of external diameter slightly greater than the diameter of the polygonal section shaft and a cap, the underside of which is annular in a plane perpendicular to the elongation of the shaft and the top being conical, domed or frusto-conical.

7. The fixing according to claim 1 further comprising a central axial hole through which a secondary fastener may be passed.
